(19) United States
(12) Patent Application Publication
(10) Pub. No.: US 2026/0270447 A1
(43) Pub. Date: Sep. 10, 2026

(54) VIDEO CODING METHOD AND APPARATUS, VIDEO DECODING METHOD AND APPARATUS, AND COMPUTER-READABLE MEDIUM

(71) Applicant: Tencent Technology (Shenzhen) Company Limited, Shenzhen, Guangdong (CN)

(72) Inventor: Xiaozhong XU, Shenzhen (CN)

(73) Assignee: Tencent Technology (Shenzhen) Company Limited, Shenzhen, Guangdong (CN)

(21) Appl. No.: 19/671,853

(22) Filed: May 8, 2026

Related U.S. Application Data
(63) Continuation of application No. PCT/CN2025/104232, filed on Jun. 27, 2025.

(30) Foreign Application Priority Data
Jul. 31, 2024 (CN) 202411052948.1

(51) Int. Cl. H04N 19/167; H04N 19/107; H04N 19/11; H04N 19/139; H04N 19/159; H04N 19/176; H04N 19/52; H04N 19/593

(52) U.S. Cl. CPC H04N 19/167; H04N 19/107; H04N 19/11; H04N 19/139; H04N 19/159; H04N 19/176; H04N 19/52; H04N 19/593

(57) ABSTRACT

A video decoding method performed by at least one processor includes obtaining prediction modes of a current block and a target block adjacent to the current block; obtaining a boundary-extended region of the target block when one of the current block and the target block uses an intra prediction mode and the other one of the current block and the target block uses an inter prediction mode, the boundary-extended region comprising at least one of a set of M rows or N columns of pixels extended from boundaries of the target block and the current block to the current block, M and N being positive integers; adjusting a pixel value close to a boundary in the current block based on a pixel value in an extended pixel region, to obtain an adjusted pixel value; and generating decoded data corresponding to the current block based on the adjusted pixel value.

### CROSS-REFERENCE TO RELATED APPLICATIONS

This application is a bypass continuation application of International Patent Application No. PCT/CN2025/104232, filed on Jun. 27, 2025, which claims priority to and is based on Chinese Patent Application No. 202411052948.1, filed on Jul. 31, 2024, the disclosures of which are incorporated herein in their entireties by reference.

### FIELD

The present disclosure relates to the field of computer and communication technologies, and in particular, to a video coding method and apparatus, a video decoding method and apparatus, and a computer-readable medium.

### BACKGROUND

In the field of video coding and decoding, an intra prediction mode is configured to derive a predicted value of a current coding block from an adjacent coded region based on a correlation between pixels of a video image in a spatial domain. In the inter prediction mode, pixels of a current image are predicted by using pixels of a neighboring coded image based on a correlation in a video temporal domain, to effectively remove redundancy from the video temporal domain.

### SUMMARY

Some embodiments of the present disclosure provide a video coding method and apparatus, a video decoding method and apparatus, and a computer-readable medium, to solve a problem that boundary pixels of intra prediction and inter prediction are easily discontinuous, enhance continuity of the boundary pixels of the intra prediction and the inter prediction, and then improve visual quality of an image.

Other features and advantages of the present disclosure become apparent through the following detailed descriptions, or may be partially learned through the practice of the present disclosure.

Some embodiments of the present disclosure provide a video decoding method performed by at least one processor. The video decoding method includes obtaining prediction modes of a current block and a target block adjacent to the current block; obtaining a boundary-extended region of the target block when one of the current block and the target block uses an intra prediction mode and the other one of the current block and the target block uses an inter prediction mode, the boundary-extended region including at least one of a set of M rows or N columns of pixels extended from boundaries of the target block and the current block to the current block, M and N being positive integers; adjusting a pixel value close to a boundary in the current block based on a pixel value in an extended pixel region, to obtain an adjusted pixel value; and generating decoded data corresponding to the current block based on the adjusted pixel value.

Some embodiments of the present disclosure provide a video decoding apparatus. The video decoding apparatus includes at least one memory configured to store computer program code; and at least one processor configured to read the program code and operate as instructed by the program code. The program code includes prediction mode obtaining code configured to cause the at least one processor to obtain prediction modes of a current block and a target block adjacent to the current block; extended region obtaining code configured to cause the at least one processor to obtain a boundary-extended region of the target block when one of the current block and the target block uses an intra prediction mode and the other one of the current block and the target block uses an inter prediction mode, the boundary-extended region including at least one of a set of M rows or N columns of pixels extended from boundaries of the target block and the current block to the current block; adjustment code configured to cause the at least one processor to adjust a pixel value at a position close to a boundary in the current block based on a pixel value in an extended pixel region, to obtain an adjusted pixel value; and processing code configured to cause the at least one processor to generate decoded data corresponding to the current block based on the adjusted pixel value.

Some embodiments of the present disclosure provide, a non-transitory computer-readable storage medium, storing computer program code, when executed by at least one processor, causes the at least one processor to at least, obtain prediction modes of a current block and a target block adjacent to the current block; obtain a boundary-extended region of the target block when one of the current block and the target block uses an intra prediction mode and the other one of the current block and the target block uses an inter prediction mode, the boundary-extended region including at least one of a set of M rows or N columns of pixels extended from boundaries of the target block and the current block to the current block, M and N being positive integers; adjust a pixel value close to a boundary in the current block based on a pixel value in an extended pixel region, to obtain an adjusted pixel value; and generate decoded data corresponding to the current block based on the adjusted pixel value.

Some embodiments of the present disclosure provide a video coding method performed by at least one processor. The video coding method includes obtaining prediction modes of a current block and a target block adjacent to the current block, obtaining a boundary-extended region of the target block when one of the current block and the target block uses an intra prediction mode and the other one of the current block and the target block uses an inter prediction mode, the boundary-extended region including a set of at least one of M rows or N columns of pixels extended from boundaries of the target block and the current block to the current block, M and N being positive integers; adjusting a pixel value at a position close to the boundary in the current block based on a pixel value in an extended pixel region, to obtain an adjusted pixel value, and coding the current block based on the adjusted pixel value.

The descriptions herein are exemplary and explanatory only and are not intended to limit the present disclosure.

### BRIEF DESCRIPTION OF THE DRAWINGS

The above and other aspects, features, and advantages of one or more embodiments of the present disclosure will be more apparent from the following description taken in conjunction with the accompanying drawings, in which:

FIG. 1 shows a schematic diagram of an exemplary system architecture to which the technical solutions in the embodiments of the present disclosure may be applied;

FIG. 2 shows a schematic diagram of arrangement modes of a video coding apparatus and a video decoding apparatus in a streaming transmission system;

FIG. 3 shows a basic flowchart of a video coder;

FIG. 4 shows a schematic diagram of an angle prediction direction in an intra prediction mode.

FIG. 5 shows a schematic diagram of intra prediction;

FIG. 6 shows a schematic diagram of an inter prediction process;

FIG. 7 shows a schematic diagram of an inter prediction process;

FIG. 8 shows a flowchart of a video decoding method according to some embodiments of the present disclosure;

FIG. 9 shows a flowchart of a video coding method according to some embodiments of the present disclosure;

FIG. 10 shows a schematic diagram of a boundary-extended region according to some embodiments of the present disclosure;

FIG. 11 shows a schematic diagram of a boundary-extended region of an inter prediction mode according to some embodiments of the present disclosure;

FIG. 12 shows a schematic diagram of a boundary pixel fusion process according to some embodiments of the present disclosure;

FIG. 13 shows a block diagram of a video decoding apparatus according to some embodiments of the present disclosure;

FIG. 14 shows a block diagram of a video coding apparatuses according to some embodiments of the present disclosure;

FIG. 15 shows a schematic diagram of a structure of a computer system suitable for implementing an electronic device according to an embodiment of the present disclosure;

### DETAILED DESCRIPTION

Exemplary implementations are now described in a more comprehensive mode with reference to the accompanying drawings. However, the exemplary implementations can be implemented in various forms and should not be understood as being limited to these examples. On the contrary, providing these implementations will make the present disclosure more comprehensive and complete, and will comprehensively convey the concept of the exemplary implementations to those skilled in the art.

In addition, the features, structures, or characteristics described in the present disclosure may be combined in one or more embodiments in any appropriate mode. The following description has many specific details, so that the embodiments of the present disclosure can be fully understood. However, a person skilled in the art is to be aware that, technical solutions of the present disclosure may be implemented without using all detailed features in the embodiments, one or more particular details may be omitted, or other methods, elements, apparatuses, or operations may be used.

In the embodiments of the present disclosure, a term “module” or “unit” refers to a computer program having a predetermined function or a part of a computer program, and operates together with other relevant parts to achieve a predetermined objective, and may be all or partially implemented by using software, hardware (such as a processing circuit or a memory), or a combination thereof. Similarly, one processor (or a plurality of processors or memories) may be configured to implement one or more modules or units. In addition, each module or unit may be a part of an overall module or unit including a function of the module or unit.

The block diagrams shown in the accompanying diagrams are merely functional entities and may not necessarily correspond to physically independent entities. For example, these functional entities can be implemented in software form, or in one or more hardware modules or integrated circuits, or in different networks and/or processor apparatuses and/or microcontroller apparatuses.

The flowcharts shown in the accompanying drawings are only exemplary illustrations and do not necessarily include all the content and operations/steps, nor does they have to be executed in the order described. For example, some operations/steps can be decomposed, while other operations/steps can be merged or partially merged, so an actual execution order may change based on actual situations.

“A plurality of” mentioned herein means two or more. The term “and/or” describes an association relationship of associated objects, representing that three relationships may exist. For example, A and/or B may represent three situations: A exists alone; A and B exist simultaneously; and B exists alone. The character “/” usually indicates an “or” relationship between associated objects.

The terms “a,” “an,” “the,” and similar referents in the context of describing the disclosed embodiments (especially in the claims) are to be construed to cover both singular and plural forms, unless otherwise indicated or clearly contradicted by context. The number of items in a plurality is at least two, but may be more when indicated explicitly or by context.

Terms such as “comprising,” “having,” “including,” and “containing” are to be construed as open-ended (meaning “including, but not limited to”) unless otherwise noted. These terms specify the presence of stated features, numbers, steps, operations, elements, components, or combinations thereof, but do not preclude the presence or addition of other features, numbers, steps, operations, elements, components, or combinations thereof.

Terms such as “set” (e.g., “a set of items”) or “subset” unless otherwise noted or contradicted by context, is to be construed as a nonempty collection including one or more members. Further, unless otherwise noted or contradicted by context, term “subset” of a corresponding set does not necessarily denote a proper subset of corresponding set, but subset and corresponding set may be equal.

Further, unless stated otherwise or otherwise clear from context, phrase “based on” may refer to “based at least in part on” and not “based solely on.”

The terms “first,” “second,” “third,” and the like in the description and in the claims, if any, are used for distinguishing between similar elements and not necessarily for describing a sequential or chronological order. It is to be understood that the terms so used are interchangeable under appropriate circumstances.

The term, involved in the following description, “some embodiments” describes subsets of all possible embodiments, but “some embodiments” may be the same subset or different subsets of all the possible embodiments and may be combined with each other without conflict.

The operations, techniques, and processes described herein may be implemented via executable instructions or computer program code stored on computer-readable medium. Such computer program code may include distinct portions or modules, where each portion comprises a subset of the total instructions to perform specific operations.

With regard to the description of the drawings, similar reference numerals may be used to refer to similar or related components.

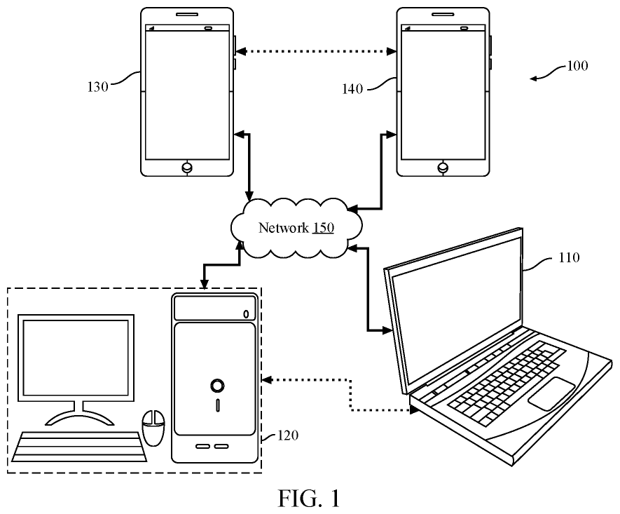

FIG. 1 shows a schematic diagram of an exemplary system architecture to which the technical solutions in the embodiments of the present disclosure may be applied.

As shown in FIG. 1, a system architecture 100 includes a plurality of terminal apparatuses. The terminal apparatuses may communicate with each other over, for example, a network 150. For example, the system architecture 100 may include a first terminal apparatus 110 and a second terminal apparatus 120 that are connected to each other through the network 150. In some embodiments of FIG. 1, the first terminal apparatus 110 and the second terminal apparatus 120 perform unidirectional data transmission.

For example, the first terminal apparatus 110 may code video data (e.g. a video picture stream captured by the terminal apparatus 110) for transmission to the second terminal apparatus 120 by using the network 150, coded video data is transmitted in the form of one or more coded video bitstreams, and the second terminal apparatus 120 may receive the coded video data from the network 150, decode the coded video data to restore the video data, and display video pictures according to the restored video data.

In some embodiments of the present disclosure, the system architecture 100 may include a third terminal apparatus 130 and a fourth terminal apparatus 140 that perform bidirectional transmission of coded video data. The bidirectional transmission may occur, for example, during a video conference. For bidirectional data transmission, each of the third terminal apparatus 130 and the fourth terminal apparatus 140 may code video data (for example, a video picture stream acquired by the terminal apparatus) for transmission to the other terminal apparatus of the third terminal apparatus 130 and the fourth terminal apparatus 140 through the network 150. Each of the third terminal apparatus 130 and the fourth terminal apparatus 140 may further receive coded video data transmitted by the other of the third terminal apparatus 130 and the fourth terminal apparatus 140, may decode the coded video data to restore the video data, and may display video pictures on an accessible display apparatus according to the restored video data.

In some embodiments shown in FIG. 1, the first terminal apparatus 110, the second terminal apparatus 120, the third terminal apparatus 130, and the fourth terminal apparatus 140 may be servers or terminals, but the principle disclosed in the present disclosure may not be limited thereto.

The server may be an independent physical server, or may be a server cluster or a distributed system formed by a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. The terminal may be a smartphone, a tablet computer, a notebook computer, a desktop computer, a smart speaker, a smart voice interaction device, a smart watch, a smart household appliance, an on-board terminal, an aircraft, or the like. It is not limited thereto.

The network 150 shown in FIG. 1 represents any quantity of networks that include, for example, wired and/or wireless communication networks, and transmit the coded video data among the first terminal apparatus 110, the second terminal apparatus 120, the third terminal apparatus 130, and the fourth terminal apparatus 140. The communication network 150 may enable data switching in circuit-switched and/or packet-switched channels. The network may include a telecommunication network, a local area network, a wide area network and/or the Internet. For the purposes of the present disclosure, unless explained below, an architecture and topology of the network 150 may be immaterial to operations disclosed in the present disclosure.

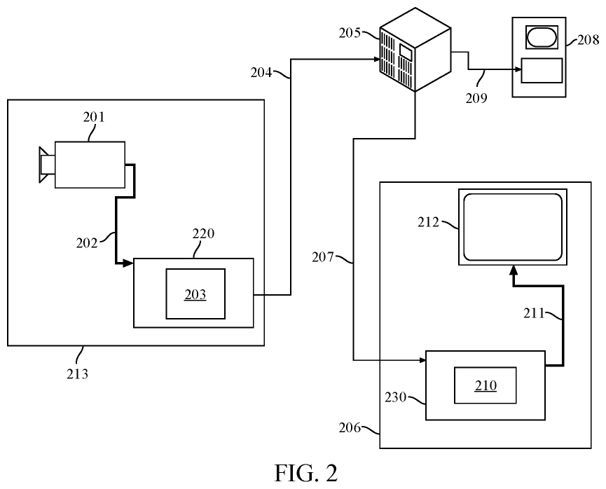

In some embodiments of the present disclosure, FIG. 2 shows arrangement modes of a video coding apparatus and a video decoding apparatus in a streaming transmission environment. The subject disclosed in the present disclosure may be equally applicable to other video-supporting applications, including, for example, video conferencing, a digital television (TV), and storage of a compressed video on a digital medium including a compact disc (CD), a digital versatile disc (DVD), a storage stick, and the like.

A streaming transmission system may include a capture subsystem 213. The capture subsystem 213 may include a video source 201 such as a digital camera. The video source creates a video picture stream 202 that is uncompressed. In some embodiments, the video picture stream 202 includes samples captured by the digital camera. The video picture stream 202 is depicted as a bold line to emphasize a video picture stream with a high data volume when compared to coded video data 204 (e.g., encoded video bitstream). The video picture stream 202 may be processed by an electronic apparatus 220. The electronic apparatus 220 includes a video coding apparatus 203 coupled to the video source 201. The video coding apparatus 203 may include hardware, software, or a combination of software and hardware, to implement or carry out each aspect of the disclosed subject described below in more details. The coded video data 204 (e.g., coded video bitstream) is depicted as a thin line to emphasize the coded video data 204 (e.g., coded video bitstream) with a lower data volume when compared to the video picture stream 202, which may be stored on a streaming transmission server 205 for future use. One or more streaming transmission client subsystems, such as a client subsystem 206 and a client subsystem 208 in FIG. 2, may access the streaming transmission server 205 to retrieve a copy 207 and a copy 209 of the encoded video data 204. The client subsystem 206 may include, for example, a video decoding apparatus 210 in an electronic apparatus 230. The video decoding apparatus 210 decodes the inputted copy 207 of the coded video data, and generates an output video picture stream 211 that may be displayed on a display 212 (for example, a display screen) or another display apparatus. In some streaming transmission systems, the coded video data 204, a copy 207 of the encoded video data, and a copy 209 of the encoded video data (e.g., video bitstreams) may be coded based on certain video coding/compression standards.

The electronic apparatus 220 and the electronic apparatus 230 may include other components. For example, the electronic apparatus 220 may include a video decoding apparatus, and the electronic apparatus 230 may further include a video coding apparatus.

In some embodiments of the present disclosure, by taking an international video coding standard such as high efficiency video coding (HEVC), versatile video coding (VVC), and a Chinese national video coding standard such as an audio video coding standard (AVS) as examples, when a video image frame is inputted, the video image frame can be partitioned into a plurality of non-overlapping processing units according to a block size, and a similar compression operation is performed on each processing unit. The processing unit is referred to as a coding tree unit (CTU), or referred to as a largest coding unit (LCU). The CTU may be further partitioned into one or more basic coding units (CU). A CU may be a most basic element in a coding phase.

In some other embodiments, the processing unit may alternatively be referred to as a coding tile, and is a rectangular region of a multimedia data frame that can be independently decoded and coded. In an alliance for open media video 1 (AV1) standard formulated by the Alliance for Open Media, a code tile may be further partitioned downward more finely, to obtain one or more superblocks (SBs). An SB is a starting point of block partition, and may be further partitioned into a plurality of sub-blocks, and then the SB is further partitioned downward, to obtain one or more blocks. Each block is a most basic element in the coding phase. In some embodiments, one SB may include a plurality of Bs.

The foregoing partition manner for the video image frame may be referred to as a block partition structure. The following describes some concepts in a coding process.

Predictive coding: The predictive coding includes modes such as intra prediction and inter prediction. After an original video signal is predicted by using a selected reconstructed video signal, a residual video signal is obtained. A coder side needs to determine a predictive coding mode to be selected for a current CU (block), and notify a decoder side. The intra prediction means that a predicted signal is from a region that has been reconstructed by coding and that is in a same picture. The inter prediction means that the predicted signal comes from a coded image (referred to as a reference image) that is different from a current image.

Transform & Quantization: After a residual video signal undergoes a transform operation such as discrete fourier transform (DFT) or discrete cosine transform (DCT), the signal is converted into a transform domain, which is referred to as a transform coefficient. Lossy quantization is further performed on the transform coefficient, to lose certain information, so that a quantized signal is beneficial to compression and expression. In some video coding standards, more than one transform mode may be selected. Therefore, the coder side also needs to select one of the transform modes for the currently CU (or block), and inform the decoder side. Quantization fineness is usually determined by a quantization parameter (QP). A larger value of the QP indicates that coefficients within a larger value range are quantized to the same output. Therefore, larger distortion and a lower bit rate are usually caused. On the contrary, a smaller value of QP indicates that coefficients in a smaller value range are to be quantized into the same output. Therefore, smaller distortion is usually caused, corresponding to a higher bit rate.

Entropy coding or statistical coding: Statistical compression coding is performed on a quantized transform domain signal based on a frequency of occurrence of each value, and finally a binarized (0 or 1) compressed bitstream is outputted. In addition, entropy coding also needs to be performed on other information generated through coding, for example, a selected coding mode and motion vector data, to reduce the bit rate. Statistical coding is a lossless coding mode that can effectively reduce a bit rate desired for expressing a same signal. A common statistical coding mode includes variable length coding (VLC) or context adaptive binary arithmetic coding (CABAC).

A context-based CABAC process mainly includes three operations: binarization, context modeling, and binary arithmetic coding. After binarization is performed on an inputted syntactic element, binary data may be coded in a normal coding mode and a bypass coding mode. The bypass coding mode does not desire assignment of a specific probability model to each binary bit, and an inputted binary bit bin value is directly coded using a simple bypass coder to speed up the entire coding and decoding process. In some examples, different syntactic elements are not completely independent of each other, and the same syntactic element also has particular memorization. Therefore, according to a conditional entropy theory, using other coded syntactic elements for conditional coding can further enhance coding performance compared with independent coding or memoryless coding. Such coded symbolic information that is used as a condition is referred to as context. In the regular coding mode, binary bits of a syntactic element sequentially enter a context modeler. The coder assigns a suitable probability model for each inputted binary bit based on a value of a previously coded syntactic element or binary bit. This process is referred to as context modeling. A context model corresponding to the syntactic element may be positioned by using a context index increment (ctxIdxInc) and a context index start (ctxIdxStart). After the bin value and the assigned probability model are inputted together into a binary arithmetic coder for coding, the context model needs to be updated based on the bin value. This is an adaptive process in the coding.

Loop filtering: A reconstructed image may be obtained by performing operations such as inverse quantization, inverse transform, and prediction and compensation on a changed and quantized signal. The reconstructed image has some information different from that in an original image due to the impact of quantization, e.g., the reconstructed image may cause distortion. Therefore, a filtering operation may be performed on the reconstructed image by, for example, a filter such as a deblocking filter (DB), sample adaptive offset (SAO), or an adaptive loop filter (ALF), to effectively reduce a distortion degree generated by quantization. Since the filtered reconstructed images are to be used as a reference for subsequently coded images to predict future image signals, the foregoing filtering operation is also referred to as loop filtering, e.g., a filtering operation in a coding loop.

One or more components of FIG. 2 may be integrated into a single component, or conversely, a single component may be implemented as multiple discrete elements. Additionally or alternatively, different subsets of the illustrated components may be combined in various configurations.

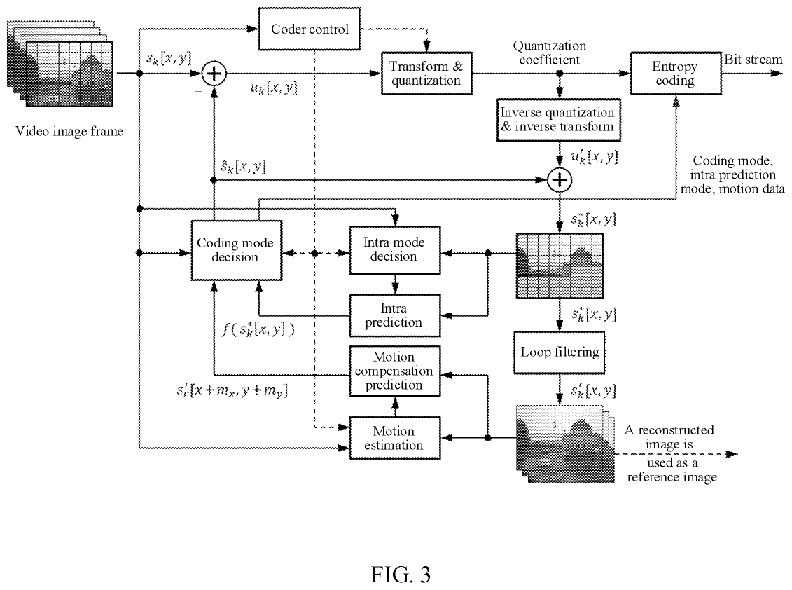

In some embodiments of the present disclosure, FIG. 3 shows a basic flowchart of a video coder. In this process, the intra prediction is used as an example for description. A difference operation is performed on an original image signal sₖ[x, y] and a predicted image signal sₖ[x, y] to obtain a residual signal uₖ[x, y]. The residual signal uₖ[x, y] is transformed and quantized to obtain a quantization coefficient. Entropy coding is performed on the quantization coefficient to obtain a coded bit stream. In addition, inverse quantization and inverse transform are performed to obtain a reconstructed residual signal u′ₖ[x, y]. The predicted image signal ŝₖ[x, y]ŝₖ[x, y] and the reconstructed residual signal u′ₖ[x, y] are superimposed to generate an image signal

$${s}_{k}^{*} [ x , y ] .$$

in one aspect, the image signal

$${s}_{k}^{*} [ x , y ]$$

is inputted to an intra mode decision module and an intra prediction module for intra prediction. In another aspect, loop filtering is performed to output a reconstructed image signal s′ₖ[x, y]. The reconstructed mage signal s′ₖ[x, y] may be used as a next frame of reference image for motion estimation and motion compensation prediction. Then, a next frame of predicted image signal ŝₖ[x, y] is obtained based on a motion compensation prediction result s′ᵣ[x+mₓ, y+m_{y}] and an intra prediction result

$$f ( {s}_{k}^{*} [ x , y ] ) .$$

The foregoing process is continued to be repeated until the coding is completed.

Based on the foregoing coding process, on the decoder side, for each coding unit (or coding block), after a compressed bitstream is obtained, entropy decoding is performed to obtain various mode information and quantization coefficients. Then, inverse quantization and inverse transform are performed on the quantization coefficients to obtain a residual signal. In another aspect, based on known coding mode information, a predicted signal corresponding to the coding unit (or coding block) may be obtained. A reconstructed signal may be then obtained after the residual signal and the predicted signal are summed. The reconstructed signal performs an operation such as loop filtering to generate a final output signal. In this series of coding processes, a coding framework mainly makes a decision based on rate-distortion optimization (RDA), to select an optimal coding parameter.

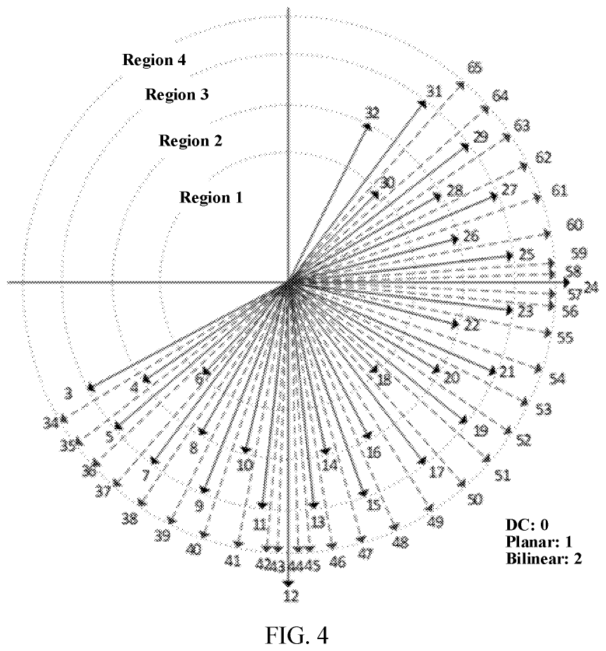

In the field of coding technologies, intra prediction is a common predictive coding technology. The intra prediction derives a predicted value of a current coding block from an adjacent coded region based on a correlation that exists between pixels of a video image in a spatial domain. A second stage of AVS3 adopts an extended intra prediction mode (EIPM). There are 33 intra prediction modes in total in previous-generation AVS2, including 30 angle prediction modes and three special prediction modes (a plane prediction mode, an average (DC) prediction mode, and a bilinear prediction mode), coding is performed by using two most probable modes (MPM), and 5-bit fixed-length coding is used in the remaining modes. To support finer angle prediction, the angle prediction modes are extended to 62 in AVS3. As shown in FIG. 4, serial numbers of newly added angle prediction modes are 34 to 65.

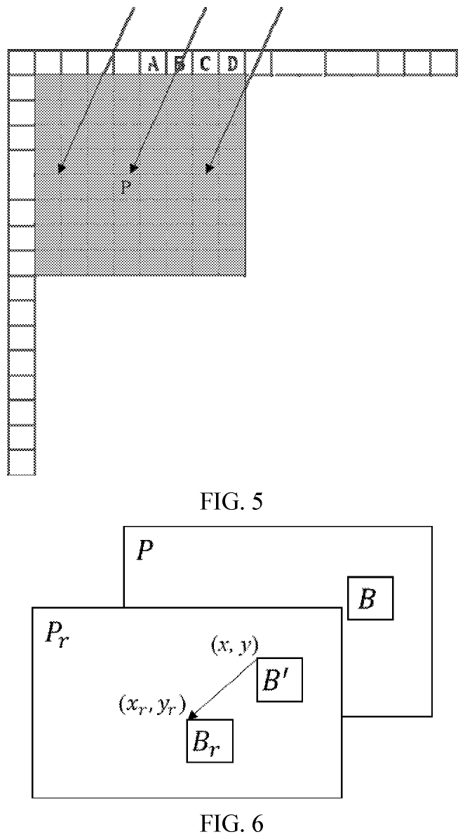

When an angle prediction mode is used, for pixel points in a current prediction block, reference pixel values at corresponding positions on reference pixel rows or columns are used as predicted values based on a direction corresponding to an angle of the prediction mode. As shown in FIG. 5, for a pixel point P in a prediction block, a position of a reference pixel is first determined from an upper coded pixel row based on a predicted angle in the figure, and then a value of the reference pixel is used as a predicted value of the pixel point P. Not all reference pixel positions pointed to by pixel positions are at integer-pixel precision. For example, in FIG. 5, the reference pixel position of the pixel point P is a sub-pixel position between a pixel B and a pixel C. Therefore, a predicted pixel value at this position needs to be obtained by interpolating surrounding pixels. To enhance intra prediction efficiency, an on-chip memory is usually used to store reference pixels for intra prediction.

For a non-angle intra prediction mode, for example, an average (DC) prediction mode, each position of a prediction block is filled with an average value after surrounding adjacent pixels are averaged.

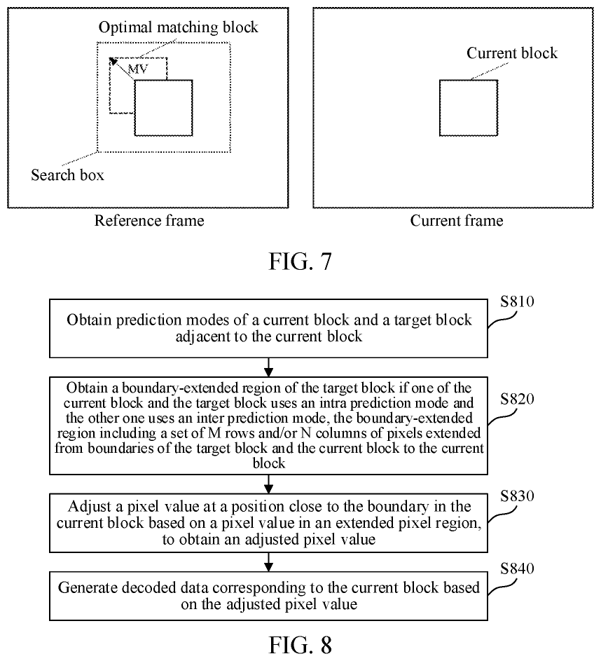

As shown in FIG. 6, the inter prediction uses a correlation in a video temporal domain, and uses pixels of a neighboring coded image to predict pixels of a current image, to achieve a purpose of effectively removing redundancy from the video temporal domain. This can effectively save bits for coding residual data, where P represents a current frame; Pr represents a reference frame; B represents a current coding block; and Br represents a reference block of B. Coordinates of B′ in the reference frame are the same as coordinates of B in the current frame. Coordinates of Br are (xᵣ, yᵣ); and the coordinates of B′ are (x, y). Displacement between the current coding block and its reference block is referred to as a motion vector (MV), where MV=(xᵣ−x, yᵣ−y). For example, the inter prediction refers to a process of performing searching on a neighboring coded image (e.g., the reference frame) based on a to-be-coded current block in the current frame, to obtain the reference block, so as to remove temporal redundancy of a video signal. As shown in FIG. 7, the to-be-coded current block in the current frame is searched within a particular range (e.g., within a search region formed by a search box) in the reference frame based on a block matching criterion, to obtain an optimal matching block. In some embodiments, common block matching criteria in video coding include matching criteria such as minimum mean square error (MSE) and sum of absolute difference (SAD).

During coding/decoding of a video image frame, when a current block using the intra prediction mode and a neighboring block using the inter prediction mode have a common boundary, a problem of discontinuity of pixels on two sides of the boundary easily occurs, thereby reducing visual quality of an image. Based on this, in the technical solutions of the embodiments of the present disclosure, for a boundary between a block in the inter prediction mode and a block using the intra prediction mode, a pixel value at a boundary position may be adjusted by using an extended pixel region of an adjacent block, so as to smooth the pixel value at the boundary, thus solving the problem of discontinuity of pixels at the boundary between intra prediction and inter prediction, enhancing continuity of the pixels at the boundary between intra prediction and inter prediction, and improving visual quality of an image.

In the technical solutions provided in some embodiments of the present disclosure, when adjacent coding blocks respectively use the intra prediction mode and the inter prediction mode, boundary optimization may be implemented by using the following solution: first obtaining a boundary-extended region (including a set of M rows and/or N columns of pixels extended from boundaries of a current block and a target block to the current block) of the target block, then adjusting a pixel value of the boundary of the current block based on a pixel value in the extended pixel region, to obtain an adjusted pixel value, and generating decoded data corresponding to the current block based on the adjusted pixel value. In view of this, in the technical solutions of the embodiments of the present disclosure, the pixel value at the boundary position of the current block is adjusted by using the extended pixel region of the adjacent block, thereby effectively solving the problem of discontinuity of pixels at an intra/inter prediction boundary, implementing smooth transitioning of boundary regions, and then significantly enhancing visual coherence of an image boundary and overall decoding quality.

The implementation details of the technical solutions of the embodiments of the present disclosure are described in detail below.

FIG. 8 shows a flowchart of a video decoding method according to some embodiments of the present disclosure. The video decoding method may be performed by a device having a computing function, for example, may be performed by a terminal device or a server. Referring to FIG. 8, the video decoding method at least includes S810 to S840, which are described in detail as follows:

S810: Obtain prediction modes of a current block and a target block adjacent to the current block.

In some embodiments, a video includes a video image frame sequence. The video image frame sequence includes a series of images. Each image may be further partitioned into slices. Each slice may further be partitioned into a series of LCUs (or CTUs), and each LCU includes a plurality of CUs. A video image frame is coded by using a block as a unit. In some new video coding standards, for example, an H.264 standard includes a macroblock (MB), and the MB may be further partitioned into a plurality of prediction blocks that may be configured for predictive coding. An HEVC standard employs basic concepts such as CU, prediction unit (PU), and transform unit (TU) to functionally partition various block units, and adopts a novel tree-based structure for description. For example, a CU may be partitioned into smaller CUs based on a quadtree, and a smaller CU may further be partitioned, to form a quadtree structure. The current block, the reference block, and the adjacent block in some embodiments of the present disclosure may be CUs or blocks smaller than a CU, for example, smaller blocks obtained by dividing a CU.

In some embodiments, a prediction mode of the current block may be an intra prediction mode or an inter prediction mode. A prediction mode used by the target block adjacent to the current block may be an intra prediction mode or an inter prediction mode.

In some embodiments, the current block and the target block may be adjacent to each other left and right, or may be adjacent to each other up and down. Since a video is coded/decoded based on a sequence from top to bottom and from left to right, the target block may be a block located on a left side of the current block, or may be a block located above the current block. In another embodiment of the present disclosure, a positional relationship between the target block and the current block may alternatively be another relationship. For example, the target block is located on an upper-left side of the current block.

S820: Obtain a boundary-extended region of the target block if one of the current block and the target block uses an intra prediction mode and the other one uses an inter prediction mode, the boundary-extended region including a set of M rows and/or N columns of pixels extended from boundaries of the target block and the current block to the current block, and M and N being positive integers.

In some embodiments, if the current block uses the intra prediction mode, the target block may use the inter prediction mode. If the current block uses the inter prediction mode, the target block may use the intra prediction mode. For example, in some embodiments of the present disclosure, one of the current block and the target block uses the intra prediction mode, and the other one uses the inter prediction mode. In other embodiments of the present disclosure, if the current block and the target block use the same prediction mode (for example, both of them use the intra prediction mode, or both of them use the inter prediction mode), boundary pixels of the current block may alternatively be adjusted by using the technical solution in some embodiments of the present disclosure.

In some embodiments, when the boundary-extended region of the target block is obtained, N columns of pixels are rightwards extended from a right boundary of the target block based on the prediction mode used by the target block, and pixel values of the N columns of pixels are determined.

In some embodiments, when the boundary-extended region of the target block is obtained, M rows of pixels are downwards extended from a lower boundary of the target block based on the prediction mode used by the target block, and pixel values of the M rows of pixels are determined.

The boundary-extended region of the target block may include a boundary-extended region on a right side, or may include a boundary-extended region below the target block, or may include both the boundary-extended region on the right side of the target block and the boundary-extended region below the target block. Certainly, in other embodiments of the present disclosure, the boundary-extended region of the target block may alternatively be a boundary-extended region in another direction, for example, a boundary-extended region on a lower-right side of the target block.

In some embodiments, the determining pixel values of the N columns of pixels based on the prediction mode used by the target block includes: determining predicted values of the N columns of pixels based on the prediction mode used by the target block; generating compensation values of the N columns of pixels based on residual values of pixels in the target block; and generating the pixel values of the N columns of pixels based on the compensation values and the predicted values. For example, the compensation values and the predicted values of the same column of pixels may be superposed to obtain a pixel value of this column. Alternatively, after the compensation values and the predicted values of the same column of pixels are superposed, a superposed value may be adjusted (for example, plus a set value, minus the set value, or multiplied by a set coefficient) to obtain a pixel value of this column.

In some embodiments, the process of determining the predicted values of the N columns of pixels based on the prediction mode used by the target block is an intra prediction process or an inter prediction process. For details, refer to the related descriptions about the inter prediction mode and the intra prediction mode in the foregoing embodiments.

If the target block uses a plurality of intra prediction modes, candidate predicted values of the N columns of pixels are respectively determined by using the plurality of intra prediction modes, and the predicted values of the N columns of pixels are calculated based on the plurality of candidate predicted values determined, for example, by weighted summation. Alternatively, one of the plurality of intra prediction modes may be selected to determine the predicted values of the N columns of pixels. For example, one of the plurality of intra prediction modes may be randomly selected or a 1^{st} intra prediction mode may be selected.

If the target block uses the inter prediction mode and has a plurality of motion vectors, the candidate predicted values of the N columns of pixels may be respectively determined by using the plurality of motion vectors, and the predicted values of the N columns of pixels are calculated based on the plurality of candidate predicted values determined, for example, by weighted summation. Alternatively, one of the plurality of motion vectors may be selected to determine the predicted values of the N columns of pixels. For example, one of the plurality of motion vectors may be randomly selected or a 1st motion vector may be selected.

In some embodiments, during the generating compensation values of the N columns of pixels based on residual values of pixels in the target block, the compensation values of each of the N columns of pixels based on the residual values of a specified column of pixels in the target block and scaling factors corresponding to each of the N columns of pixels. In some embodiments, the scaling factors corresponding to different columns of pixels in the N columns are the same or different. In some embodiments, the specified column may be a rightmost column in the target block, or may be another column in the target block.

In some embodiments, the determining pixel values of the M rows of pixels based on the prediction mode used by the target block may be: determining predicted values of the M rows of pixels based on the prediction mode used by the target block; generating compensation values of the M rows of pixels based on residual values of pixels in the target block; and generating the pixel values of the M rows of pixels based on the compensation values and the predicted values of the M rows of pixels. For example, the compensation values and the predicted values of the same row of pixels may be superposed to obtain a pixel value of this row. Alternatively, after the compensation values and the predicted values of the same row of pixels are superposed, a superposed value may be adjusted (for example, plus a set value, minus the set value, or multiplied by a set coefficient) to obtain a pixel value of this row.

In some embodiments, the process of determining the predicted values of the M rows of pixels based on the prediction mode used by the target block is an intra prediction process or an inter prediction process. For details, refer to the related descriptions about the inter prediction mode and the intra prediction mode in the foregoing embodiments.

If the target block uses a plurality of intra prediction modes, candidate predicted values of the M rows of pixels are respectively determined by using the plurality of intra prediction modes, and the predicted values of the M rows of pixels are calculated based on the plurality of candidate predicted values determined, for example, by weighted summation. Alternatively, one of the plurality of intra prediction modes may be selected to determine the predicted values of the M rows of pixels. For example, one of the plurality of intra prediction modes may be randomly selected or a 1st intra prediction mode may be selected.

If the target block uses the inter prediction mode and has a plurality of motion vectors, the candidate predicted values of the M rows of pixels may be respectively determined by using the plurality of motion vectors, and the predicted values of the M rows of pixels are calculated based on the plurality of candidate predicted values determined, for example, by weighted summation. Alternatively, one of the plurality of motion vectors may be selected to determine the predicted values of the M rows of pixels. For example, one of the plurality of motion vectors may be randomly selected or a 1st motion vector may be selected.

In some embodiments, during the generating compensation values of the M rows of pixels based on residual values of pixels in the target block, the compensation values of each of the M rows of pixels based on the residual values of a specified row of pixels in the target block and scaling factors corresponding to each of the M rows of pixels. In some embodiments, the scaling factors corresponding to different rows of pixels in the M rows are the same or different. In some embodiments, the specified row may be a lowest row in the target block, or may be another row in the target block.

Still referring to FIG. 8, in S830, a pixel value at a position close to the boundary in the current block is adjusted based on a pixel value in an extended pixel region, to obtain an adjusted pixel value.

In some embodiments, the process of adjusting the pixel value at the position close to the boundary in the current block based on the pixel value in the extended pixel region may be performing weighted summation on the pixel value in the extended pixel region and the pixel value at the position close to the boundary in the current block to obtain the adjusted pixel value.

In some embodiments, if the target block is located on a left side of the current block, weighted summation may be performed on an i^{th} column of pixel values sorted in the current block from left to right and an i^{th} column of pixel values sorted in the extended pixel region from left to right, to obtain adjusted pixel values corresponding to the i^{th} column of pixel values in the current block, i being less than or equal to N, and less than or equal to a quantity of columns of the current block. For example, the weighted summation is performed on a 1^{st} column of pixel values sorted in the current block from left to right and a 1^{st} column of pixel values sorted in the extended pixel region from left to right, to obtain adjusted pixel values corresponding to the 1^{st} column of pixel values in the current block. The weighted summation is performed on a 2^{nd} column of pixel values sorted in the current block from left to right and a 2^{nd} column of pixel values sorted in the extended pixel region from left to right, to obtain adjusted pixel values corresponding to the 2^{nd} column of pixel values in the current block.

In this case, in some embodiments, weights of the columns of pixel values sorted in the extended pixel region from left to right may sequentially decrease. For example, the weights of the 1^{st} column of pixel values sorted in the extended pixel region from left to right may be greater than the weights of the 2^{nd} column of pixel values sorted in the extended pixel region from left to right.

In some embodiments, if the target block is located above the current block, weighted summation may be performed on a j^{th} row of pixel values sorted in the current block from top to bottom and a j^{th} row of pixel values sorted in the extended pixel region from top to bottom, to obtain adjusted pixel values corresponding to the j^{th} row of pixel values in the current block, j being less than or equal to M, and less than or equal to a quantity of rows of the current block. For example, the weighted summation is performed on a 1^{st} row of pixel values sorted in the current block from top to bottom and a 1^{st} row of pixel values sorted in the extended pixel region from top to bottom, to obtain adjusted pixel values corresponding to the 1^{st} row of pixel values in the current block. The weighted summation is performed on a 2^{nd} row of pixel values sorted in the current block from top to bottom and a 2^{nd} row of pixel values sorted in the extended pixel region from top to bottom, to obtain adjusted pixel values corresponding to the 2^{nd} row of pixel values in the current block.

In this case, in some embodiments, weights of the columns of pixel values sorted in the extended pixel region from top to bottom may sequentially decrease. For example, the weights of the 1^{st} row of pixel values sorted in the extended pixel region from top to bottom may be greater than the weights of the 2^{nd} row of pixel values sorted in the extended pixel region from top to bottom.

S840: Generate decoded data corresponding to the current block based on the adjusted pixel value.

In some embodiments, after the pixel value at the position close to the boundary in the current block is adjusted, the adjusted pixel value at the position close to the boundary in the current block and pixel values at other positions (e.g., positions that are not adjusted) in the current block may be used as reconstructed pixel values of the current block, to obtain the decoded data corresponding to the current block, and later, other blocks in the image frame may be decoded based on the reconstructed pixel values.

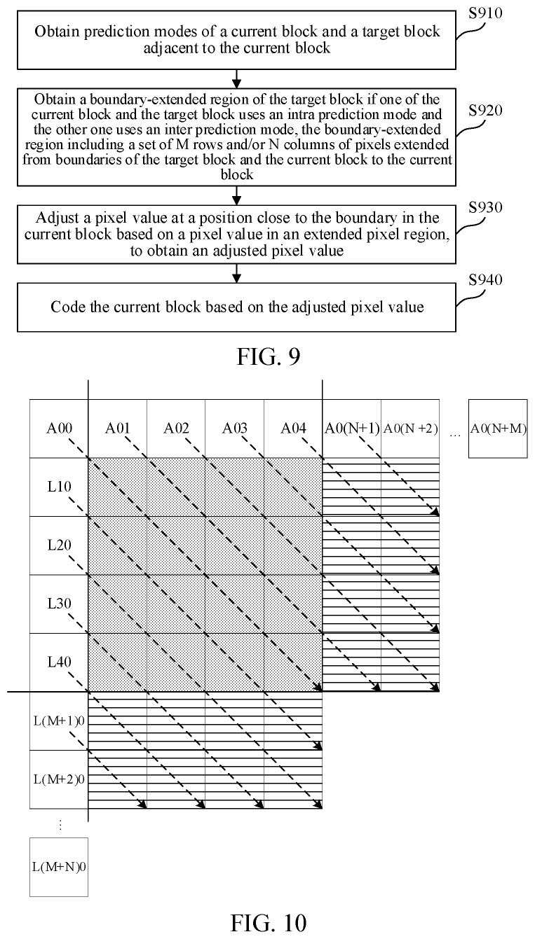

FIG. 8 describes the technical solution of some embodiments of the present disclosure from the perspective of video decoding. The following describes the technical solution of some embodiments of the present disclosure again from the perspective of video coding with reference to FIG. 9.

FIG. 9 shows a flowchart of a video coding method according to some embodiments of the present disclosure. The video coding method may be performed by a device having a computing function, for example, may be performed by a terminal device or a server. Referring to FIG. 9, the video coding method at least includes S910 to S940, which are described in detail as follows:

S910: Obtain prediction modes of a current block and a target block adjacent to the current block.

S920: Obtain a boundary-extended region of the target block if one of the current block and the target block uses an intra prediction mode and the other one uses an inter prediction mode, the boundary-extended region including a set of M rows and/or N columns of pixels extended from boundaries of the target block and the current block to the current block, and M and N being positive integers.

S930: Adjust a pixel value at a position close to the boundary in the current block based on a pixel value in an extended pixel region, to obtain an adjusted pixel value.

S940: Code the current block based on the adjusted pixel value.

A processing process of a video coder side is similar to a processing process of a video decoder side. For details, refer to the foregoing processing process related to the decoder side, and details are not described herein again.

In view of this, in the technical solution in some embodiments of the present disclosure, by using a fusion method for boundary pixels for intra prediction and inter prediction, continuity of the boundary pixels is maintained, thereby achieving a purpose of improving visual quality of a boundary region. In addition, the configurable M and N parameters are applicable to different block sizes (4×4 to 64×64), so as to avoid overfitting caused by fixed extension. An original prediction structure inside the current block is reserved by adjusting only the pixels in the boundary region, so that calculation complexity is controllable. In addition, data in an extended region can be multiplexed with an existing cache line, thereby reducing the number of memory accesses.

The following describes implementation details of the technical solutions in the embodiments of the present disclosure again with reference to FIG. 10 to FIG. 12.

In some embodiments of the present disclosure, boundaries of blocks in a video image frame may be extended. Extension on the current block is used as an example below for description.

In some embodiments, for the current block using the intra prediction mode, based on a region of the current block (which may be, for example, S columns×T rows), N columns of pixels are rightwards extended, and M rows of pixels are downwards extended. Pixels in the extended regions may be generated based on the intra prediction mode corresponding to the current block. In some embodiments, an intra prediction object may be considered as a block with (S+N) columns×(T+M) rows, to determine predicted values of the pixels in the extended regions. For example, if the current block uses a horizontal prediction direction, the N columns of pixel on the right are all generated by horizontal prediction on a column of reference pixels on the left. The M rows of pixels below are generated by horizontal prediction on M reference pixels on the left.

In some embodiments, when reference pixels on the upper-right side and the lower-left side of the current block are needed and some reference pixels do not exist, these reference pixels may be filled with neighboring existing reference pixels. FIG. 10 shows an example in which the pixels in the extended regions are generated by using a lower-right 45-degree prediction direction. If A0 (N+1) does not exist, it may be replaced with a pixel A0N (i.e. A04). In some embodiments, in the example shown in FIG. 10, M may be equal to N, a value of which may be 2.

In some embodiments, since the N columns of pixels, which are extended and generated by using the foregoing mode, only include predicted values, but no residual values, the N columns of pixels may be different from actually reconstructed pixels to an extent. Therefore, in some embodiments of the present disclosure, for the N columns of extended regions on the right, it may be considered that residual values of pixels in a rightmost column (for example, a 4^{th} column in FIG. 2) of the current block are multiplied by a scaling factor, and is then added to predicted pixels of the extended regions on the right, to obtain pixel values of the extended regions on the right. In some embodiments, the scaling factors corresponding to the columns in the extended regions may be the same or different.

Similarly, since the M rows of predicted pixel regions, which are extended and generated by using the foregoing mode, only include predicted values, but no residual values, the M rows of predicted pixel regions may be different from actually reconstructed pixels to an extent. Therefore, in some embodiments of the present disclosure, for the M rows of extended regions below, it may be considered that residual values of pixels in a lowest row (for example, a 4^{th} row in FIG. 2) of the current block are multiplied by a scaling factor, and is then added to predicted pixels in the extended regions below, to obtain pixel values of the extended regions below. In some embodiments, the scaling factors corresponding to the rows in the extended regions may be the same or different.

In some embodiments, if the current block uses a plurality of intra prediction modes (e.g., has a plurality of prediction blocks), the current block may be processed by using the following mode:

In one mode, the current block may be used as a block with (S+N) columns×(T+M) rows. For the intra prediction modes, predicted pixels of a plurality of extended regions are generated based on the mode for generating a prediction block of the current block in the foregoing embodiment, and then weighted summation is performed, to obtain a predicted pixel of a final extended region. In some embodiments, the weighted summation mode may be performed with reference to a mode for generating a final prediction block by means of a plurality of intra predictions.

Another mode may be selecting one intra prediction mode. For example, a 1^{st} intra prediction mode is selected to generate the predicted pixels of the extended regions.

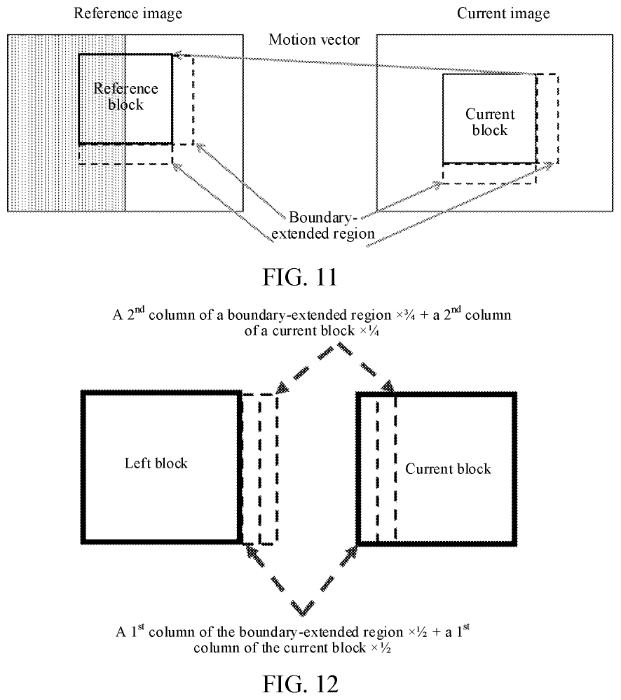

In some embodiments, for the current block using the inter prediction mode, based on a region of the current block (which may be, for example, S columns×T rows), N columns of pixels are rightwards extended, and M rows of pixels are downwards extended. The pixels in the extended regions may be generated by finding corresponding reference positions in a reference image based on a motion vector indication of the current block. As shown in FIG. 11, predicted values of pixels in a boundary-extended region of a current block in a current image are obtained based on pixels in a boundary-extended region of a reference block in a reference image.

In some embodiments, since the N columns of pixels, which are extended and generated by using the foregoing mode, only include predicted values, but no residual values, the N columns of pixels may be different from actually reconstructed pixels to an extent. Therefore, in some embodiments of the present disclosure, for the N columns of extended regions on the right, it may be considered that residual values of pixels in a rightmost column (for example, a 4^{th} column in FIG. 2) of the current block are multiplied by a scaling factor, and is then added to predicted pixels of the extended regions on the right, to obtain pixel values of the extended regions on the right. In some embodiments, the scaling factors corresponding to the columns in the extended regions may be the same or different.

Similarly, since the M rows of predicted pixel regions, which are extended and generated by using the foregoing mode, only include predicted values, but no residual values, the M rows of predicted pixel regions may be different from actually reconstructed pixels to an extent. Therefore, in some embodiments of the present disclosure, for the M rows of extended regions below, it may be considered that residual values of pixels in a lowest row (for example, a 4^{th} row in FIG. 2) of the current block are multiplied by a scaling factor, and is then added to predicted pixels in the extended regions below, to obtain pixel values of the extended regions below. In some embodiments, the scaling factors corresponding to the rows in the extended regions may be the same or different.

In some embodiments, if the current block has a plurality of motion vectors (e.g., has a plurality of reference blocks), the current block may be processed by using the following mode:

In one mode, the current block may be used as a block with (S+N) columns×(T+M) rows. Reference blocks of a plurality of reference regions are obtained for the motion vectors. Predicted pixels of the extended regions are generated based on a mode for generating a prediction block of the current block. If the predicted pixels of a plurality of extended regions are generated, weighted summation may be performed, to obtain a predicted pixel of a final extended region.

Another mode is selecting one motion vector. For example, a 1^{st} motion vector is selected to generate the predicted pixels of the extended regions.

When blocks in a video image frame are extended at a boundary, each block may be extended in advance. In this way, when a boundary-extended region of a block needs to be used, the boundary-extended region may be directly obtained. Alternatively, when a boundary-extended region of a block needs to be used, the boundary-extended region of the block may be generated by using the technical solution of the foregoing embodiment.

In some embodiments, for two adjacent coding blocks, if a coding mode satisfies that one coding block uses intra prediction and the other one uses inter prediction, boundary pixels of a current block may be fused by using a boundary pixel fusion method.

For example, a weighted summation operation is performed one by one on each of the previous N columns of pixels in the current block from left to right and each of the N columns of extended pixel regions on the right of a left block of the current block. For example, weighted summation is performed on a 1^{st} column of pixels in the current block from left to right and a 1^{st} column of pixels in an extended pixel region on the right of the left block, to generate a reconstructed pixel at a last position of the 1^{st} column of the current block. Weighted summation is performed on a 2^{nd} column of pixels in the current block from left to right and a 2^{nd} column of pixels in an extended pixel region on the right of the left block, to generate a reconstructed pixel at a last position of the 2^{nd} column of the current block. The rest can be deduced by analogy.

A weighted summation operation is performed one by one on each of the previous M rows of pixels in the current block from top to bottom and on each of the M rows of extended pixel regions below an upper block of the current block. For example, weighted summation is performed on a 1^{st} row of pixels in the current block from top to bottom and a 1^{st} row of pixels in an extended pixel region below the upper block, to generate a reconstructed pixel at a last position of the 1^{st} row of the current block. Weighted summation is performed on a 2^{nd} row of pixels in the current block from top to bottom and a 2^{nd} row of pixels in an extended pixel region below the upper block, to generate a reconstructed pixel at a last position of the 2^{nd} row of the current block. The rest can be deduced by analogy.

In some embodiments, for each row/column in the boundary-extended region, weights in the weighted summation may sequentially decrease since a distance to the boundary increases. For example, as shown in FIG. 12, assuming that M=N=2, a pixel weight of a first row/column in the boundary-extended region is set to ½ (correspondingly, a pixel weight of a row/column at the corresponding position of the current block is set to ½). A pixel weight of a second row/column in the boundary-extended region is set to ¼ (correspondingly, a pixel weight of a row/column at the corresponding position of the current block is set to ¾).

In the foregoing solution of the foregoing embodiment of the present disclosure, smoothing is performed on the boundaries of the intra prediction and the inter prediction, so that continuity of the boundaries of the intra prediction and the inter prediction can be enhanced, thereby improving visual quality of coding. The technical solutions of the foregoing embodiments may be used alone, or may be used after being combined. In addition, the technical solutions of the embodiments of the present disclosure may be applied to a product related to a video codec or video compression.

The following describes an apparatus embodiment of the present disclosure, which may be configured to perform the method in the foregoing embodiments of the present disclosure. For details not disclosed in the apparatus embodiment of the present disclosure, refer to the foregoing embodiment of the method of the present disclosure.

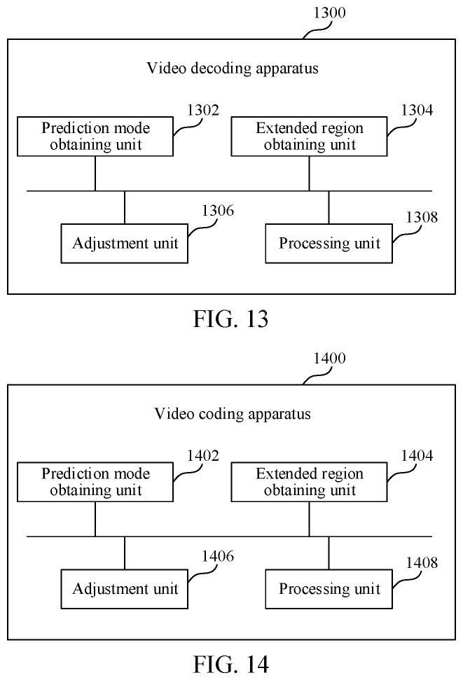

FIG. 13 shows a block diagram of a video decoding apparatus according to some embodiments of the present disclosure. The video decoding apparatus may be disposed within a device having a computing function, for example, may be disposed within a terminal device or a server.

Referring to FIG. 13, the video decoding apparatus 1300 according to some embodiments of the present disclosure includes a prediction mode obtaining unit 1302, an extended region obtaining unit 1304, an adjustment unit 1306, and a processing unit 1308.

The prediction mode obtaining unit 1302 is configured to obtain prediction modes used by a current block and a target block adjacent to the current block. The extended region obtaining unit 1304 is configured to obtain a boundary-extended region of the target block if one of the current block and the target block uses an intra prediction mode and the other one uses an inter prediction mode, the boundary-extended region including a set of M rows and/or N columns of pixels extended from boundaries of the target block and the current block to the current block. The adjustment unit 1306 is configured to adjust a pixel value at a position close to the boundary in the current block based on a pixel value in an extended pixel region, to obtain an adjusted pixel value. The processing unit 1308 is configured to generate decoded data corresponding to the current block based on the adjusted pixel value.

One or more components of FIG. 13 may be integrated into a single component, or conversely, a single component may be implemented as multiple discrete elements. Additionally or alternatively, different subsets of the illustrated components may be combined in various configurations.

FIG. 14 shows a block diagram of a video coding apparatus according to some embodiments of the present disclosure. The video coding apparatus may be disposed within a device having a computing function, for example, may be disposed within a terminal device or a server.

Referring to FIG. 14, the video coding apparatus 1400 according to some embodiments of the present disclosure includes a prediction mode obtaining unit 1402, an extended region obtaining unit 1404, an adjustment unit 1406, and a processing unit 1408.

The prediction mode obtaining unit 1402 is configured to obtain prediction modes used by a current block and a target block adjacent to the current block. The extended region obtaining unit 1404 is configured to obtain a boundary-extended region of the target block if one of the current block and the target block uses an intra prediction mode and the other one uses an inter prediction mode, the boundary-extended region including a set of M rows and/or N columns of pixels extended from boundaries of the target block and the current block to the current block, and M and N being positive integers. The adjustment unit 1406 is configured to adjust a pixel value at a position close to the boundary in the current block based on a pixel value in an extended pixel region, to obtain an adjusted pixel value. The processing unit 1408 is configured to code the current block based on the adjusted pixel value.

For specific functions and implementations of the video decoding apparatus shown in FIG. 13 and the video coding apparatus shown in FIG. 14, refer to the foregoing method embodiments, and details are not described herein again.

One or more components of FIG. 14 may be integrated into a single component, or conversely, a single component may be implemented as multiple discrete elements. Additionally or alternatively, different subsets of the illustrated components may be combined in various configurations.

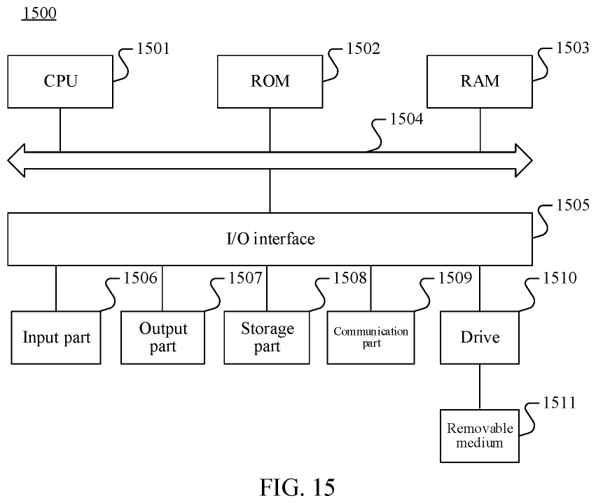

FIG. 15 shows a schematic diagram of a structure of a computer system suitable for implementing an electronic device according to an embodiment of the present disclosure. The electronic device may be the video coding apparatus or the video decoding apparatus in the foregoing embodiment.

The computer system 1500 of the electronic device shown in FIG. 15 is merely an example, and does not constitute any limitation on the functions and scope of use of the embodiments of the present disclosure.

As shown in FIG. 15, the computer system 1500 includes a central processing unit (CPU) 1501, which may perform various suitable actions and processing based on a program stored in a read-only memory (ROM) 1502 or a program loaded from a storage part 1508 into a random access memory (RAM) 1503, for example, perform the method in the foregoing embodiment. The RAM 1503 further stores various programs and data for system operations. The CPU 1501, the ROM 1502, and the RAM 1503 are connected to each other through a bus 1504. An input/output (I/O) interface 1505 is also connected to the bus 1504.

The following components may be connected to the I/O interface 1505: an input part 1506 including a keyboard, a mouse, and the like; an output part 1507 such as a cathode ray tube (CRT), a liquid crystal display (LCD), a speaker, and the like; a storage part 1508 including a hard disk drive; and a communication part 1509 including a local area network (LAN) card, a modem, and the like. The communication part 1509 performs communication processing by using a network such as the Internet. A drive 1510 is also connected to the I/O interface 1505. A removable medium 1511, such as a magnetic disk, an optical disk, a magneto-optical disk, and a semiconductor memory, is installed on the drive 1510, so that a computer program read from the removable medium is installed into the storage part 1508.

One or more components of FIG. 15 may be integrated into a single component, or conversely, a single component may be implemented as multiple discrete elements. Additionally or alternatively, different subsets of the illustrated components may be combined in various configurations.

For example, according to an embodiment of the present disclosure, the processes described above by referring to the flowcharts may be implemented as computer software programs. For example, some embodiments of the present disclosure includes a computer program product, including a computer program carried on a computer-readable medium, and the computer program is configured to perform the method shown in the flowchart. In such an embodiment, the computer program may be downloaded and installed from a network through the communication part 1509, and/or installed from the removable medium 1511. When the computer program is executed by the CPU 1501, various functions defined in the system of the present disclosure are performed.

The computer-readable medium in the embodiments of the present disclosure can be a computer-readable signal medium, a computer-readable storage medium, or any combination of the computer-readable signal medium and the computer-readable storage medium. The computer-readable storage medium can be, for example, but not limited to, electric, magnetic, optical, electromagnetic, infrared, or semiconductor systems, apparatuses, or devices, or any combination of the above. More specific examples of the computer-readable storage medium may include, but are not limited to: an electrical connection with one or more wires, a portable computer disk, a hard disk drive, a RAM, a ROM, an erasable programmable read only memory (EPROM), a flash memory, an optical fiber, a compact disc read-only memory (CD-ROM), an optical storage device, a magnetic storage device, or any suitable combination of the above. In the present disclosure, the computer-readable storage medium may be any tangible medium containing or storing a computer program, and the computer program may be used by or used in combination with an instruction execution system, an apparatus, or a device. In the present disclosure, the computer-readable signal medium may include a data signal being in a baseband or propagated as a part of a carrier wave, which carries computer-readable computer programs. This propagated data signal may use various forms, including, but not limited to, an electromagnetic signal, an optical signal, or any suitable combination thereof. The computer-readable signal medium may alternatively be any computer-readable medium other than a computer-readable storage medium. The computer-readable medium can send, propagate, or transmit programs for use by or use in combination with an instruction execution system, apparatus, or device. The computer program included in the computer-readable medium may be transmitted by using any suitable medium, including but not limited to: a wireless medium, a wired medium, and the like, or any suitable combination thereof.

The flowcharts and block diagrams in the accompanying drawings illustrate possible system architectures, functions and operations that may be implemented by a system, a method, and a computer program product according to various embodiments of the present disclosure. Each box in the flowcharts or block diagrams may represent a module, a program segment, or a part of code. The module, the program segment, or the part of code includes one or more executable instructions configured for implementing specified logic functions. In some alternative implementations, functions annotated in the blocks may also be executed in a different order from those annotated in the accompanying drawings. For example, two boxes shown in succession may actually be performed basically in parallel, and sometimes the two boxes may be performed in a reverse order. This depends on the functions involved. Each box in the block diagrams or flowcharts and a combination of boxes in the block diagrams or the flowcharts may be implemented by using a dedicated hardware-based system configured to perform a specified function or operation, or may be implemented by using a combination of dedicated hardware and a computer program.

A related unit described in the embodiments of the present disclosure may be implemented in a software mode, or may be implemented in a hardware mode, and the unit described can also be set in a processor. The names of the units do not constitute a limitation on the units in a situation.

In another aspect, the present disclosure further provides a computer-readable medium. The computer-readable medium may be included in the electronic device described in the foregoing embodiment or exist alone and is not installed into the electronic device. The computer-readable medium carries one or more computer programs. The one or more computer programs, when executed by the electronic device, cause the electronic device to implement the method in the foregoing embodiment.

Some implementations may relate to a system, a method, and/or a computer-readable medium at any possible level of integration technical details. The computer-readable medium may include a computer-readable non-transitory storage medium (or a plurality of media). The computer-readable non-transitory storage medium has a computer-readable program instruction for causing a processor to perform an operation, and may alternatively store a bitstream (or a video bitstream) generated based on the foregoing coding method. When the computer program/instruction is executed by the processor, the operations of the video coding method may be implemented to generate a bit stream (e.g., a video bitstream), or the operations of the video decoding method may be implemented to decode the bit stream (e.g., the video bitstream).

Although a plurality of modules or units of a device configured to perform actions are mentioned in the foregoing detailed description, such partitioning is not mandatory. In fact, based on the implementations of the present disclosure, features and functions of two or more modules or units described above may be embodied in one module or unit. On the contrary, the features and functions of one module or unit described above may further be partitioned to be embodied by a plurality of modules or units.

Through the foregoing descriptions of the implementations, a person skilled in the art may readily understand that the exemplary implementations described herein may be implemented by software, or may be implemented by combining software with corresponding hardware. Therefore, the technical solutions of the implementations of the present disclosure may be implemented in a form of a software product. The software product may be stored in a non-volatile storage medium (which may be a CD-ROM, a USB flash drive, a removable hard disk drive, or the like) or on a network, including a plurality of instructions to cause an electronic device to perform the method according to the implementations of the present disclosure.

For example, the electronic device may be a video decoding apparatus, and then the video decoding apparatus may perform the video decoding method shown in FIG. 8. For another example, the electronic device may be a video coding apparatus, and the video coding apparatus may perform the video coding method shown in FIG. 9.

Those skilled in the art will easily come up with other implementations of the present disclosure after considering the present disclosure and implementing the implementations disclosed herein. The present disclosure is intended to cover any variations, usages, or adaptive changes of the present disclosure. These variations, usages, or adaptive changes follow the general principle of the present disclosure and include common general knowledge or common technical means in the technical field not disclosed in the present disclosure.

The present disclosure is not limited to the precise structures described above and shown in the accompanying drawings, and various modifications and changes can be made without departing from the scope of the present disclosure. The scope of the present disclosure is subject only to the appended claims.

What is claimed is:

1. A video decoding method, performed by at least one processor, the video encoding method comprising:
obtaining prediction modes of a current block and a target block adjacent to the current block;
obtaining a boundary-extended region of the target block when one of the current block and the target block uses an intra prediction mode and the other one of the current block and the target block uses an inter prediction mode, the boundary-extended region comprising at least one of a set of M rows or N columns of pixels extended from boundaries of the target block and the current block to the current block, M and N being positive integers;
adjusting a pixel value close to a boundary in the current block based on a pixel value in an extended pixel region, to obtain an adjusted pixel value; and
generating decoded data corresponding to the current block based on the adjusted pixel value.

2. The video decoding method according to claim 1, wherein the obtaining of the boundary-extended region of the target block comprises:
extending N columns of pixels rightwards from a right boundary of the target block based on one of the prediction modes used by the target block, and determining pixel values of the N columns of pixels; and
extending M rows of pixels downwards from a lower boundary of the target block based on one of the prediction modes used by the target block, and determining pixel values of the M rows of pixels.

3. The video decoding method according to claim 2, wherein the determining of the pixel values of the N columns of pixels comprises:
determining predicted values of the N columns of pixels based on one of the prediction modes used by the target block;
generating compensation values of the N columns of pixels based on residual values of pixels in the target block; and
generating the pixel values of the N columns of pixels based on the compensation values and the predicted values of the N columns of pixels.

4. The video decoding method according to claim 3, wherein the generating of the compensation values of the N columns of pixels comprises:
calculating the compensation values of each of the N columns of pixels based on the residual values of a specified column of pixels in the target block and scaling factors corresponding to each of the N columns of pixels,
wherein the scaling factors corresponding to different columns of pixels in the N columns is the same or different.

5. The video decoding method according to claim 4, wherein the specified column comprises a rightmost column in the target block.

6. The video decoding method according to claim 5, wherein the determining of the predicted values of the N columns of pixels comprises:
when the target block uses a plurality of intra prediction modes:
determining candidate predicted values of the N columns of pixels by using the plurality of intra prediction modes, and calculating the predicted values of the N columns of pixels based on the candidate predicted values determined; or
selecting one of the plurality of intra prediction modes to determine the predicted values of the N columns of pixels; and
when the target block uses the inter prediction mode and has a plurality of motion vectors:
determining candidate predicted values of the N columns of pixels by using the plurality of motion vectors, and calculating the predicted values of the N columns of pixels based on the candidate predicted values determined; or
selecting one of the plurality of motion vectors to determine the predicted values of the N columns of pixels.

7. The video decoding method according to claim 2, wherein the determining of the pixel values of the M rows of pixels comprises:
determining predicted values of the M rows of pixels based on one of the prediction modes used by the target block;
generating compensation values of the M rows of pixels based on residual values of pixels in the target block; and
generating the pixel values of the M rows of pixels based on the compensation values and the predicted values of the M rows of pixels.

8. The video decoding method according to claim 7, wherein the generating of the compensation values of the M rows of pixels:
calculating the compensation values of each of the M rows of pixels based on the residual values of a specified row of pixels in the target block and scaling factors corresponding to each of the M rows of pixels,
wherein the scaling factors correspond to different rows of pixels in the M rows being the same or different.

9. The video decoding method according to claim 8, wherein the specified row comprises a lowest row in the target block.

10. The video decoding method according to claim 7, wherein the determining of the predicted values of the M rows of pixels comprises:
when the target block uses a plurality of intra prediction modes:
determining candidate predicted values of the M rows of pixels by using the plurality of intra prediction modes, and calculating the predicted values of the M rows of pixels based on the plurality of candidate predicted values determined; or
selecting one of the plurality of intra prediction modes to determine the predicted values of the M rows of pixels; and
when the target block uses the inter prediction mode and has a plurality of motion vectors:
determining candidate predicted values of the M rows of pixels by using the plurality of motion vectors, and calculating the predicted values of the M rows of pixels based on the plurality of candidate predicted values determined; or
selecting one of the plurality of motion vectors to determine the predicted values of the M rows of pixels.

11. The video decoding method according to claim 1, wherein the adjusting of the pixel value at a position close to the boundary in the current block based on a pixel value in the extended pixel region, to obtain the adjusted pixel value comprises:
performing weighted summation on the pixel value in the extended pixel region and the pixel value at the position close to the boundary in the current block, to obtain the adjusted pixel value.

12. The video decoding method according to claim 11, wherein the performing of the weighted summation on the pixel value in the extended pixel region and the pixel value at the position close to the boundary in the current block comprises:
performing, when the target block is located on a left side of the current block, the weighted summation on an i^{th} column of pixel values sorted in the current block from left to right and an i^{th} column of pixel values sorted in the extended pixel region from left to right, to obtain adjusted pixel values corresponding to the i^{th} column of pixel values in the current block,
wherein i is:
less than or equal to N, and
less than or equal to a quantity of columns of the current block.

13. The video decoding method according to claim 12, wherein weights of columns of pixel values sorted in the extended pixel region from left to right sequentially decrease.

14. The video decoding method according to claim 11, wherein the performing of the weighted summation on the pixel value in the extended pixel region and the pixel value at the position close to the boundary in the current block comprises:
performing, when the target block is located above the current block, the weighted summation on a j^{th} row of pixel values sorted in the current block from top to bottom and a j^{th} row of pixel values sorted in the extended pixel region from top to bottom, to obtain adjusted pixel values corresponding to the j^{th} row of pixel values in the current block,
wherein j is:
less than or equal to M, and
less than or equal to a quantity of rows of the current block.

15. The video decoding method according to claim 14, wherein weights of rows of pixel values sorted in the extended pixel region from top to bottom sequentially decrease.

16. A video decoding apparatus, comprising:
at least one memory configured to store computer program code; and at least one processor configured to read the program code and operate as instructed by the program code, the program code comprising:
prediction mode obtaining code configured to cause the at least one processor to obtain prediction modes of a current block and a target block adjacent to the current block;
extended region obtaining code configured to cause the at least one processor to obtain a boundary-extended region of the target block when one of the current block and the target block uses an intra prediction mode and the other one of the current block and the target block uses an inter prediction mode, a boundary-extended region comprising at least one of a set of M rows or N columns of pixels extended from boundaries of the target block and the current block to the current block;
adjustment code configured to cause the at least one processor to adjust a pixel value at a position close to the boundary in the current block based on a pixel value in an extended pixel region, to obtain an adjusted pixel value; and
processing code configured to cause the at least one processor to generate decoded data corresponding to the current block based on the adjusted pixel value.

17. The video decoding apparatus according to claim 16, wherein the extended region obtaining code is further configured to cause the at least one processor to:
extend N columns of pixels rightwards from a right boundary of the target block based on one of the prediction modes used by the target block, and determining pixel values of the N columns of pixels; and
extend M rows of pixels downwards from a lower boundary of the target block based on one of the prediction modes used by the target block, and determining pixel values of the M rows of pixels.

18. The video decoding apparatus according to claim 17, wherein the extended region obtaining code is further configured to cause the at least one processor to:
determine predicted values of the N columns of pixels based on one of the prediction modes used by the target block;
generate compensation values of the N columns of pixels based on residual values of pixels in the target block; and
generate the pixel values of the N columns of pixels based on the compensation values and the predicted values of the N columns of pixels.

19. The video decoding apparatus according to claim 18, wherein the extended region obtaining code is further configured to cause the at least one processor to:
calculate the compensation values of each of the N columns of pixels based on the residual values of a specified column of pixels in the target block and scaling factors corresponding to each of the N columns of pixels,
wherein the scaling factors corresponding to different columns of pixels in the N columns is the same or different.

20. A non-transitory computer-readable storage medium, storing computer program code, when executed by at least one processor, causes the at least one processor to at least:
obtain prediction modes of a current block and a target block adjacent to the current block;
obtain a boundary-extended region of the target block when one of the current block and the target block uses an intra prediction mode and the other one of the current block and the target block uses an inter prediction mode, the boundary-extended region comprising at least one of a set of M rows or N columns of pixels extended from boundaries of the target block and the current block to the current block, M and N being positive integers;
adjust a pixel value close to a boundary in the current block based on a pixel value in an extended pixel region, to obtain an adjusted pixel value; and
generate decoded data corresponding to the current block based on the adjusted pixel value.
